(19) United States
(12) Patent Application Publication
(10) Pub. No.: US 2017/0131114 A1
(43) Pub. Date: May 11, 2017

(54) VEHICLE DATA PROCESSING METHOD AND VEHICLE TERMINAL

(71) Applicant: Leauto Intelligent Technology (BEIJING) Co. Ltd., Beijing (CN)

(72) Inventors: Dan Li, Beijing (CN); Yu Zou, Beijing (CN); Wei Lin, Beijing (CN); Yong Xu, Beijing (CN); Kunsheng Chen, Beijing (CN); Wenrui Li, Beijing (CN); Peng Liu, Beijing (CN)

(73) Assignee: Leauto Intelligent Technology (BEIJING) Co. Ltd., Beijing (CN)

(21) Appl. No.: 14/979,776

(22) Filed: Dec. 28, 2015

(30) Foreign Application Priority Data
Nov. 6, 2015 (CN) 201510753680.9

(51) Int. Cl. G01C 21/36; G01S 19/42; G08G 1/0967; G01C 21/32; G08G 1/0968; G08G 1/0969

(52) U.S. Cl. CPC G01C 21/3694; G08G 1/096844; G08G 1/0969; G08G 1/0967; G01C 21/32; G01S 19/42

(57) ABSTRACT

The present disclosure provides a vehicle data processing method and a vehicle terminal for solving the problem in the prior arts. The method comprises receiving a running data sharing packet sent by a first peripheral device in a vehicular temporary network, wherein the running data sharing packet comprises road condition data shot by a front vehicle; sharing the running data sharing packet with a second peripheral device in the vehicular temporary network; and determining the information of the front road according to the road condition data shot by the front vehicle, and displaying the information of the front road. A rear vehicle can acquire the front road condition information data in time through the peripheral device; and the running vehicle can acquire the front road condition information in time, so that the running vehicle can make corresponding operation or change the running route.

### CROSS-REFERENCE TO RELATED APPLICATIONS

Pursuant to 35 U.S.C. §119 and the Paris Convention Treaty, this application claims the benefit of Chinese Patent Application No. 2015107536809 filed on Nov. 6, 2015, entitled “vehicle data processing method and vehicle terminal”, the contents of which are incorporated herein by reference.

### FIELD OF TECHNOLOGY

The present disclosure relates to the technical field of vehicles, and particularly relates to a vehicle data processing method and a vehicle terminal.

### BACKGROUND

At present, forward-looking systems of vehicles are mainly used on two parts, i.e., driving recorders and driving safety warning systems. A driving recorder is used for recording the road condition ahead of a vehicle when the vehicle runs, so as to record and analyze an accident. A driving safety warning system is represented by Mobileye, and has such driving aided safety warning functions as pedestrian detection, lane departure and the like.

The above-mentioned forward-looking system of the vehicle serves the vehicle on the basis of the visual angle of the vehicle. However, when the vehicle actually runs on a road, the road condition is generally complex, e.g., sudden traffic accidents, invisible ramps, invisible tortuous roads and the like still belong to visual blind areas for drivers, the specific road condition is difficult to learn when the vehicle is not driven to the corresponding position, and the vehicle cannot pre judge some complex conditions.

Therefore, a technical problem to be urgently solved by those skilled in the art at present is to propose a vehicle data processing method for acquiring the front road condition in time.

### SUMMARY

One objective of the embodiments of the present disclosure is to provide a vehicle data processing method and a vehicle terminal, which may solve the problem that the front road condition cannot be acquired in time in the prior art.

To achieve the objective, one embodiment of present disclosure provides a vehicle data processing method including receiving a running data sharing packet sent by a first peripheral device in a vehicular temporary network, wherein the running data sharing packet includes road condition data shot by a front vehicle; sharing the running data sharing packet with a second peripheral device in the vehicular temporary network; and determining the information of the front road according to the road condition data shot by the front vehicle, and displaying the information of the front road.

Another embodiment of the present disclosure provides a vehicle terminal that includes a processor and a display, wherein the vehicle and roadside fixed device communication module is used for receiving a running data sharing packet sent by a first peripheral device in a vehicular temporary network, and sharing the running data sharing packet with a second peripheral device in the vehicular temporary network, and the running data sharing packet includes road condition data shot by a front vehicle; the processor is used for determining the information of the front road according to the road condition data shot by the front vehicle; and the display is used for displaying the information of the front road.

According to the embodiments of the present disclosure, a temporary network is established for all the vehicles within a certain distance threshold of a peripheral device, a vehicle in the network can receive the running data sharing packet sent by the peripheral device, the processor analyzes the running data sharing packet to obtain front road condition information data, and the display displays the front road condition information data; the running data sharing packet may also be shared with the peripheral device, so that a rear vehicle can acquire the front road condition information data in time through the peripheral device; and the running vehicle can acquire the front road condition information in time, so that the running vehicle can make corresponding operation or change the running route.

### BRIEF DESCRIPTION OF THE DRAWINGS

In order to describe the technical solutions in the embodiments of the present disclosure or in the prior art more clearly, a simple introduction on the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 is a structural block diagram of a vehicle terminal of an embodiment of the present disclosure;

FIG. 2 is a step flow diagram of a data processing method of an embodiment of the present disclosure;

FIG. 3 is a structural block diagram of a vehicle terminal of another embodiment of the present disclosure;

FIG. 4 is a step flow diagram of a data processing method of another embodiment of the present disclosure.

### DESCRIPTION OF THE EMBODIMENTS

To achieve the objective, technical solutions and advantages of the embodiments of the present disclosure clearer, a clear and complete description of the technical solutions in the present disclosure will be given below, in combination with the accompanying drawings in the embodiments of the present disclosure. Apparently, the embodiments described below are a part, but not all, of the embodiments of the present disclosure. All of the other embodiments, obtained by those of ordinary skill in the art based on the embodiments of the present disclosure without any inventive efforts, fall into the protection scope of the present disclosure.

When a vehicle runs, the front road condition is generally predicted through a vehicular forward-looking system in the prior art, whereas the rear vehicle cannot acquire the front road condition information in time, e.g., an invisible road condition cannot be accurately predicted; thus, no matter whether the front vehicle or the rear vehicle acquiring the front road condition (e.g., bump, pit, jam, accumulated water, a large number of large-sized transport vehicles and the like) in time can benefit the rear vehicle in making a running route planning or a driving operation (e.g., braking, overtaking and the like) as early as possible. Accordingly, the embodiments of the present disclosure provide a vehicle data processing method and a vehicle terminal, wherein a vehicle can establish a vehicular temporary network on the basis of V2X (Vehicle-to-X) communication technology, to notify a peripheral device such as a fixed terminal or a vehicle terminal installed on other vehicle in the vehicular temporary network of road condition data, so as to acquire the front road condition in time.

### Embodiment 1

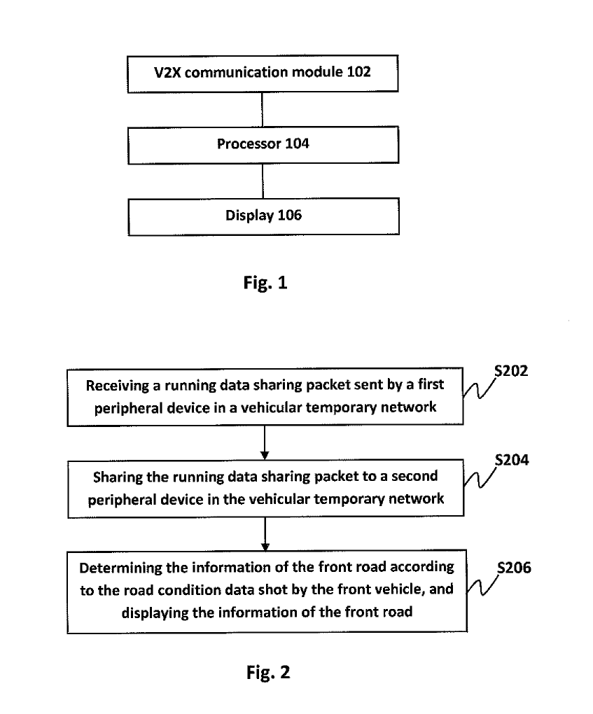

See FIG. 1, which shows a structural block diagram of a vehicle terminal of an embodiment of the present disclosure. The vehicle terminal specifically may include a V2X communication module 102, a display 106 and a processor 104.

The V2X communication module 102 and the display 106 are respectively connected with the processor 104; the V2X communication module 102 is used for receiving a running data sharing packet sent by a first peripheral device in a vehicular temporary network, and sharing the running data sharing packet with a second peripheral device in the vehicular temporary network, wherein the running data sharing packet includes road condition data shot by a front vehicle; the processor 104 is used for determining the information of the front road according to the road condition data shot by the front vehicle; and the display 106 is used for displaying the information of the front road.

A temporary network may be established between a running vehicle within a certain distance preset range and a peripheral device through the V2X communication module 102, road condition data is acquired through the front vehicle, the running data sharing packet is sent to the peripheral device, and the running vehicle within a certain distance threshold range of the peripheral device may receive the running data sharing packet within a certain time threshold range. In the embodiment of the present disclosure, the peripheral device includes various devices in the temporary network, e.g. a roadside fixed device with V2X communication function, or other vehicles with V2X communication function.

Wherein, the V2X communication module 102 establishes a temporary network between a running vehicle within a certain distance threshold range and a roadside fixed device on the basis of V2X, e.g. establishes a temporary network between a vehicle within 300-1000 meters of a peripheral device and a roadside fixed device.

Wherein, V2X indicates communication between a vehicle and a peripheral device, i.e., information exchange between the vehicle and the outside, thus, X includes a vehicle terminal, a roadside fixed terminal, a server and the like, and V2X realizes communication between vehicles and vehicles, vehicles and base stations, and base stations and base stations. Thus, such a series of traffic information as real-time road condition, road information, pedestrian information and the like may be acquired, to improve the driving safety, reduce jam, improve the traffic efficiency, provide vehicle-mounted amusement information and the like. A vehicular temporary network may be established during communication based on the V2X technology, terminals may wirelessly communicate with each other through the V2X communication module, and the wireless communication technology follows an IEEE802.11P protocol. Wherein, all the V2X communication modules within a certain distance threshold (e.g., 300-4000 meters) range may establish the temporary network, and each V2X communication module can carry out wireless communication and share the running data sharing packet. For example, the designed transmission distance is 300-1000 m, the transmission rate is 3M-27 Mbps, and then V2X is mainly used in the fields of intelligent traffic and driving active safety, to reduce traffic accidents and improve the traffic efficiency. Compared with 3G/LTE, V2X communication has the advantages that the transmission instantaneity is high and a base station, operator traffic and fee are not needed.

After the temporary network is established, the running vehicles in the temporary network may interact with each other, or the running vehicles not in the same temporary network may also interact with each other through a roadside terminal, e.g., receive a running data sharing packet sent by the peripheral device, share the running data sharing packet with the running vehicles in the temporary network through the V2X communication module, or send the running data sharing packet to a roadside fixed device through the V2X communication module, so that when the following vehicles pass by the roadside fixed device, the roadside fixed device sends the running data sharing packet to the following vehicles.

For example, when a certain vehicle runs to a range of 300-1000 meters of the peripheral device, the vehicle receives the running data sharing packet sent by the peripheral device and shared by the front vehicle, and if within 300-1000 meters of the peripheral device, when the road condition that vehicles stop or slow down appears in the front of the running road, the vehicle acquires a running data packet of front road condition information, and shares the running data packet with the peripheral device closest to the vehicle as a sharing packet.

The peripheral device may include a roadside fixed device, and may be installed on a roadside signpost, a bridge, a street lamp or a special independent mounting bracket, wherein the distance between the roadside fixed devices may be set according to the actual road condition, e.g., the roadside fixed devices on curves or rugged roads may be closer, while the roadside fixed devices on flat roads may be farther.

After the running vehicle receives the running data sharing packet, the processor 104 analyzes the running data sharing packet to obtain front road condition information data, which includes picture data and position data of the front road condition; and the display 106 displays the front road condition information data.

See FIG. 2, which shows a step flow diagram of a vehicle data processing method of an embodiment of the present disclosure.

The method may specifically include the following steps:

Step 202, a running data sharing packet sent by a first peripheral device in a vehicular temporary network is received.

When a vehicle runs, the running vehicle establishes a temporary network connection with the peripheral device within a certain threshold range (e.g., 300-1000 meters) through a V2X communication module, wherein the peripheral device includes other running vehicle or a roadside fixed device in the temporary network.

The running vehicle receives the running data sharing packet sent by the first peripheral device in the temporary network through the V2X communication module, wherein the sharing packet is sent by the V2X communication module in the first peripheral device, and the first peripheral device may be other running vehicle terminals or a roadside fixed device in the temporary network. The running data sharing packet includes road condition data shot by a front vehicle.

Step S204, the running data sharing packet is shared to a second peripheral device in the vehicular temporary network.

The running vehicle runs forward all the time, and the vehicular temporary network may be changed, so after receiving the running data sharing packet, the vehicle immediately sends the running data sharing packet to the second peripheral device in the current vehicular temporary network, wherein the second peripheral device includes other running vehicles or a roadside fixed device in the current temporary network;

Step S206, front road information is determined according to the road condition data shot by the front vehicle, and is displayed.

The road condition data shot by the front vehicle is obtained by analyzing the running data sharing packet; the processor may search the current running route on a map according to the analyzed road condition data, position road information corresponding to the road condition data, i.e., position information and make a corresponding mark; and the display displays the marked road information on the map, thus facilitating corresponding operation.

According to the embodiment of the present disclosure, a temporary network is established for all the vehicles within a certain distance threshold of a peripheral device, a vehicle in the network can receive the running data sharing packet sent by the peripheral device, the processor analyzes the running data sharing packet to obtain front road condition information data, and the display displays the front road condition information data; the running data sharing packet may also be shared with the peripheral device, so that a rear vehicle can acquire the front road condition information data in time through the peripheral device; and the running vehicle can acquire the front road condition information in time, so that the running vehicle can make corresponding operation, e.g., change the running route and the like.

### Embodiment 2

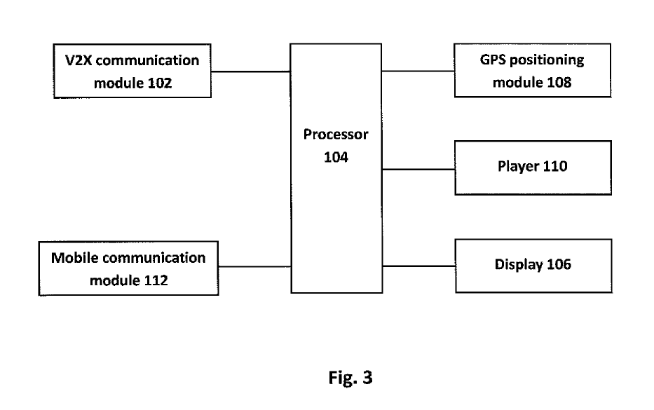

Refer to FIG. 3, which shows a structural block diagram of a vehicle terminal of another embodiment of the present disclosure. The vehicle terminal may specifically include the following modules:

a V2X communication module 102, a display 106, a GPS (Global Positioning System) positioning module 108, a player 110 and a mobile communication module 112 which are respectively connected with a processor 104.

Specifically, the V2X communication module 102 is connected with the processor 104, and is used for receiving a first broadcast message sent by a first peripheral device from a vehicular temporary network, acquiring a running data sharing packet from the first broadcast message, generating a second broadcast message according to the running data sharing packet, and sharing the second broadcast message to the vehicular temporary network within a preset time period, so that the second broadcast message is sent to a second peripheral device in the vehicular temporary network within the preset time period.

When a vehicle runs, in order that the running vehicle may acquire front road condition information in time, the embodiment of the present disclosure proposes that the vehicle within a certain distance threshold (e.g., 300-1000 meters) range may establish a temporary network with a peripheral device through the V2X communication module 102, and exchange information with the peripheral device through the V2X communication module 102 in a vehicle terminal after the temporary network is established, so as to realize road condition information interaction of the running vehicle.

The vehicle terminal in this embodiment has the functions of GPS positioning, image acquisition, radar detection (or other detection functions), sound input, V2X communication and the like. When the front vehicle detects that the front road is abnormal through radar or image recognition or other methods, the acquisition module of the front vehicle may acquire an image of a complex road condition (e.g., a large pit, large-area accumulated water or large-sized foreign matters on the ground, etc.), and then the image is shared through the V2X communication module, so that the owner of the rear vehicle can make a pre-judgment, change the driving route or perform effective yielding. This share not only can be acquired by the vehicles within a V2X valid communication range (300-1000 m) of the current vehicle, but also can be acquired by rear vehicles within a certain time range when the road traffic flow is relatively low and even if the active sharing vehicle has gone far away.

The front vehicle shares the special road condition to surrounding vehicles and a roadside fixed device in real time through the V2X communication module, and the vehicles within the valid V2X communication range may immediately acquire the complex road condition information and make a yielding pre-judgment. When a few vehicles run on the road and no vehicle is in the valid range, the roadside fixed device may continuously broadcast the acquired information for 5 min, for example, so as to ensure that rear vehicles may still acquire the special road condition information even if no vehicles are in the front (e.g., at night), meanwhile, the fixed terminal may also send the information to the background of a relative maintenance or management department through a 3G/4G module thereof, so that background workers make a judgment and maintain the road in time to avoid road jam and accidents. (This solution and the device are particularly suitable for night roads, mountain roads and the like where the traffic flow is relatively low).

When the rear vehicle runs to a range where a temporary network may be established with the peripheral device, the rear vehicle acquires the first broadcast message sent by the first peripheral device, wherein the broadcast message includes a running data sharing packet; and in this process, the V2X communication module 102 wirelessly communicates with the peripheral device, so that the peripheral device can send a broadcast message to the V2X communication module 102.

The processor 104 acquires the running data sharing packet and generates a second broadcast message, and within a preset time period (e.g., 5 minutes), the V2X communication module 102 sends the second broadcast message to the vehicle closest to the peripheral device within the preset time period; and as the vehicle runs all the time in the execution process of the above-mentioned step, the vehicle may run to the vehicular temporary network of the next peripheral device, or is still in the vehicular temporary network of the current peripheral device.

The GPS positioning module 108 is connected with the processor 104, and is used for acquiring road condition position data from the road condition data shot by the front vehicle, acquiring current vehicle position data, and marking the road condition position data and the current vehicle position data into map data to obtain front road information generated from the marked map data; and the display 106 is connected with the processor 104, and is used for displaying the marked map data.

Specifically, the V2X communication module 102 receives the first broadcast message sent by the first peripheral device, analyzes the first broadcast message to obtain a running data sharing packet, acquires road condition data shot by a front vehicle according to the running data sharing packet, and acquires road condition position data according to the road condition data; the GPS positioning module 108 searches road condition position data on a map according to the road condition position data, acquires current vehicle position data, marks the road condition position data and the current vehicle position data into the same map data, and acquires front road information according to the map data; and the display 106 displays the position data marked on the same map.

The processor 104 is connected with the display 106, and is further used for acquiring road condition picture data from the road condition data shot by the front vehicle; and the display 106 is further used for displaying the road condition picture data.

Specifically, when the front vehicle detects the front road condition that vehicles need to stop or slow down, the front vehicle shoots the front road condition to obtain road condition data, i.e., picture data, and the current vehicle acquires the picture data from the running data sharing packet; and the display 106 displays the acquired picture data.

The processor 104 is further used for acquiring current running route information, and adjusting the running route information according to the road condition position data to obtain adjusted running route information.

Specifically, the current vehicle receives the running data sharing packet, and analyzes the sharing packet to obtain front road condition information; and the processor 104 searches current running route information on a map, and adjusts the running route as actually required according to the front road condition information to obtain adjusted running route information, e.g., rounding or slowing down and the like.

The processor 104 is connected with the player 110, and is further used for acquiring road condition audio data from the road condition data shot by the front vehicle; and the player 110 is used for playing the road condition audio data.

Specifically, the current vehicle receives the running data sharing packet sent by the front vehicle through the peripheral device, analyzes the running data sharing packet according to a database or dictionary data in the processor to obtain road condition data, and converts the road condition data into a voice fragment, wherein the voice fragment is used for describing front road condition information, e.g., a curve in the front, please slow down, or the front road is under construction, please round, etc; and the player 110 plays the voice fragment to prompt drivers.

The mobile communication module 112 is connected with the processor 104, and is used for generating network data according to the running data sharing packet, and uploading the network data to a server through a mobile network, so that the server can process the road condition data.

When the road condition shot by the front vehicle can be artificially repaired to allow vehicles to pass by normally, e.g., a large pit or a large amount of accumulation appears on the ground and hinders vehicles from running, the driver may perform control to generate network data according to the generated running data sharing packet, the mobile communication module 112 (e.g., 3G/4G communication module) sends the network data to the server, and the server may effectively monitor the operation condition of the road by receiving the running data sharing packet, so that the drivers can quickly deal with emergencies to ensure smooth road operation.

The peripheral device includes a running vehicle terminal or a roadside fixed device including the V2X communication module in the vehicular temporary network.

Wherein, the roadside fixed device including the V2X communication module in the vehicular temporary network may be installed on a roadside signpost, a bridge, a street lamp or a specially-designed independent mounting bracket, wherein the distance between the roadside fixed devices may be set according to the actual road condition, e.g., the roadside fixed devices on curves or rugged roads may be closer, while the roadside fixed devices on flat roads may be farther.

The roadside fixed device is set in order to enable all the vehicles on a road to establish a vehicular temporary network, and all the vehicles on the road can acquire the front road condition information in time through the roadside fixed device.

The running data sharing packet shared by the advancing vehicle is acquired through the V2X communication module, and the running data sharing packet may include pictures, voice prompt, GPS information and the like of the front special road condition (e.g., large-sized falling rocks or pits) shot by the vehicle. The information is broadcast in real time for a certain period of time through the V2X module, e.g., 5 minutes, and the time may be appropriately prolonged or shortened according to rugged mountain roads, country roads or urban roads or according to nights or days, so that the rear vehicles running to the valid range of the terminal can still acquire the sharing packets of other vehicles passing within 5 minutes on the roads where no front vehicles run and the traffic flow is low.

The sharing packet has specific GPS position of a special road, the terminal module also has specific GPS position thereof, and the positions can be used for determining specific directions of double parties, so as to deduce the specific position of a complex road and the relative position with the terminal module.

Moreover, after receiving the data packet shared by the vehicle, the device may immediately send the information to the background server of a relative maintenance or management department through a 3G/4G communication module, so that background workers make a judgment and maintain the road in time to avoid road jam and accidents. (This solution and the device are particularly suitable for night roads, mountain roads and the like where the traffic flow is relatively low).

According to the embodiment of the present disclosure, a temporary network is established for all the vehicles within a certain distance threshold of a peripheral device, a vehicle in the network can receive the running data sharing packet sent by the peripheral device, the processor analyzes the running data sharing packet to obtain front road condition information data, and the display displays the front road condition information data; the running data sharing packet may also be shared with the peripheral device, so that a rear vehicle can acquire the front road condition information data in time through the roadside fixed device, and the running vehicle can acquire the front road condition information in time; the position can be accurately located by adding the GPS positioning module, the player and the mobile communication module; the road condition information is broadcast by voice, so that the running vehicle can make corresponding operation or change the running route; and the mobile communication module is connected with the server, so that workers can monitor the road in real time and quickly deal with emergencies to ensure smooth road operation.

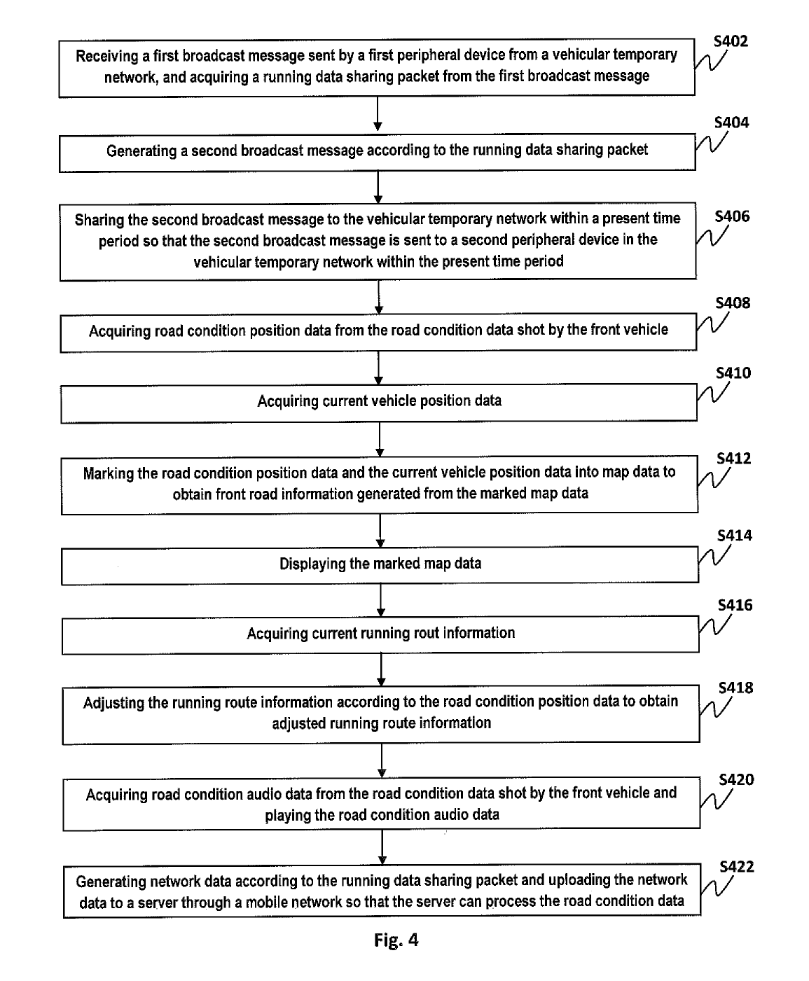

Refer to FIG. 4, which shows a step flow diagram of a data processing method of another embodiment of the present disclosure. The method may specifically include the following steps:

Step S402, a first broadcast message sent by a first peripheral device is received from a vehicular temporary network, and a running data sharing packet is acquired from the first broadcast message.

When a vehicle runs, the running vehicle establishes a temporary network connection with a peripheral device within a certain distance threshold range (e.g., 300-1000 meters) through a V2X communication module, i.e., establishes wireless communication, wherein the peripheral device includes other running vehicles or a roadside fixed device in the temporary network.

The running vehicle receives the first broadcast message sent by the first peripheral device from the temporary network through the V2X communication module, wherein the first broadcast message is sent by the V2X communication module in the first peripheral device, and the first peripheral device may be other running vehicle or a roadside fixed device in the temporary network.

After receiving the first broadcast message, the V2X communication module sends the first broadcast message to a processor; and the processor analyzes the first broadcast message to obtain a running data packet, wherein the running data sharing packet includes road condition data shot by a front vehicle.

Step S404, a second broadcast message is generated according to the running data sharing packet.

After the running data sharing packet is obtained by analyzing, the second broadcast message is generated according to the running data sharing packet, the second broadcast message is substantially the same as the first broadcast message, only the execution main body of each broadcast message is different, and the second broadcast message is used for being shared with a peripheral device within the vehicular temporary network.

Step S406, the second broadcast message is shared to the vehicular temporary network within a preset time period, so that the second broadcast message is sent to a second peripheral device in the vehicular temporary network within the preset time period.

The vehicle runs forward all the time when receiving the running data sharing packet, and the peripheral device in the temporary network may be changed, so a time period (e.g., 5 minutes) needs to be preset; the running vehicle shares the second broadcast message to the current vehicular temporary network through the V2X communication module within the time period; and the second broadcast message is sent to the searched peripheral device changed in the current vehicular temporary network within the preset time period, wherein the peripheral device may include a running vehicle or a roadside fixed device including the V2X communication module in the vehicular temporary network.

Step S408, road condition position data is acquired from the road condition data shot by the front vehicle.

Step S410, current vehicle position data is acquired.

All the running vehicles in the current vehicular temporary network can receive the second broadcast message, and can obtain the running data sharing packet by analyzing the second broadcast message; the processor analyzes the running vehicle sharing packet, i.e., analyzes the road condition data shot by the front vehicle, and determines front road condition position data; and the front road condition position data and the current vehicle position data are searched by GPS positioning.

Step S412, the road condition position data and the current vehicle position data are marked into map data to obtain front road information generated from the marked map data.

Step S414, the marked map data is displayed.

The road condition position data and the current vehicle position data positioned by GPS are displayed on the same map and marked to obtain a road condition marking map, front road information is generated according to the map and the position data, and the position data displayed on the map is displayed through a display.

Step S416, current running route information is acquired.

Step S418, the running route information is adjusted according to the road condition position data to obtain the adjusted running route information.

The driver searches the current driving route on the map according to the map data displayed by the display, and adjusts the current running route according to the current vehicle position data and the road condition position data to obtain the adjusted running route information, i.e., optimal running route, e.g., rounding in the front due to construction, and the optimal rounding route is searched according to the map.

Step S420, road condition audio data is acquired from the road condition data shot by the front vehicle, and is played.

After the running data sharing packet is received, i.e., the road condition data shot by the front vehicle is acquired, audio data for describing road condition information, i.e., a voice fragment, is obtained by analyzing the road condition data; and the voice fragment is played by the player to prompt drivers.

Step S422, network data is generated according to the running data sharing packet, and the network data is uploaded to a server through a mobile network, so that the server can process the road condition data.

When the road condition shot by the front vehicle can be artificially repaired to allow vehicles to pass by normally, e.g., a large pit or a large amount of accumulation appears on the ground and hinders vehicles from running, the driver may perform control to generate network data according to the generated running data sharing packet, the mobile communication network (e.g., 3G/4G communication network) sends the network data to the server, and the server may effectively monitor the operation condition of the road by receiving the running data sharing packet, so that the drivers can quickly deal with emergencies to ensure smooth road operation.

The embodiment of the present disclosure provides a vehicle terminal device with V2X and 3G/4G communication functions, the front vehicle shares the special road condition to the terminal device in real time through the V2X communication module, and the vehicle terminal may broadcast the information in real time for a certain period of time through the V2X module, e.g., 5 minutes, so that the farther rear vehicle can acquire the front special road condition likewise, which is logically equivalent to effectively prolonging the V2X communication distance. Meanwhile, the information may also be sent to the background of a relative maintenance or management department through a 3G/4G module thereof, so that background workers make a judgment and maintain the road in time to avoid road jam and accidents. Moreover, this solution and the device are suitable for night roads, mountain roads and the like where the traffic flow is relatively low.

According to the embodiment of the present disclosure, a temporary network is established for all the vehicles within a certain distance threshold of a peripheral device, a vehicle in the network can receive the running data sharing packet sent by the peripheral device, the processor analyzes the running data sharing packet to obtain front road condition information data, and the display displays the front road condition information data; the running data sharing packet may also be shared with a roadside fixed device, so that a rear vehicle can acquire the front road condition information data in time through the roadside fixed device, and the running vehicle can acquire the front road condition information in time; the position can be accurately located through GPS positioning, the player and the mobile communication module; the road condition information is broadcast by voice, so that the running vehicle can make corresponding operation or change the running route; and the mobile communication module is connected with the server, so that workers can monitor the road in real time and quickly deal with emergencies to ensure smooth road operation.

It should be noted that, the method embodiments are expressed as combinations of a series of actions for the purpose of simple description, but those skilled in the art should learn that the embodiments of the present disclosure are not limited by the described action sequence, because some steps may adopt other sequence or be simultaneously performed according to the embodiments of the present disclosure. Secondly, those skilled in the art should also learn that, the embodiments descried in the specification all belong to preferred embodiments, and the involved actions are not always necessary for the embodiments of the present disclosure.

The device embodiments described above are only schematic, wherein the modules illustrated as separate components may be or may not be physically separated, and the components displayed as modules may be or may not be physical modules, that is to say, the components may be positioned at one place or may also be distributed on a plurality of network modules. The objectives of the solutions of the embodiments may be fulfilled by selecting part or all of the modules according to actual needs. Those of ordinary skill in the art could understand and implement the embodiments without any creative effort.

The embodiments in the specification are described progressively, the highlight of each embodiment is a difference from other embodiments, and the similar parts among the embodiments refer to one another.

It should be appreciated by those skilled in the art that the embodiments of the present disclosure may be provided as methods, devices or computer program products. Therefore, the embodiments of the present disclosure may adopt the form of complete hardware embodiments, complete software embodiments or embodiments of software and hardware in combination. Moreover, the embodiments of the present disclosure may adopt the form of computer program products implemented on one or more computer-useable storage media (including but not limited to a magnetic disk memory, a compact disc read-only memory (CD-ROM), an optimal memory and the like) including computer-usable program codes.

The embodiments of the present disclosure are described with reference to flow diagrams and/or block diagrams of the methods, terminal devices (systems) and computer program products according to the embodiments of the present disclosure. It should be understood that each flow and/or block in the flow diagrams and/or block diagrams and combination of flows and/or blocks in the flow diagrams and/or block diagrams may be implemented by computer program instructions. These computer program instructions may be supplied to a general computer, a dedicated computer, an embedded processor or a processor of other programmable data processing terminal device to produce a machine, so that a device for achieving functions designated in one or more flows of the flow diagrams and/or one or more blocks of the block diagrams is produced through the instructions executed by the computer or the processor of the other programmable data processing terminal devices.

These computer program instructions may also be stored in a computer-readable memory capable of guiding the computer or the other programmable data processing terminal device to work in a specific mode, so as to generate a manufactured product including an instruction device through the instructions stored in the computer-readable memory, and the instruction device implements the functions designated in one or more flows of the flow diagrams and/or one or more blocks of the block diagrams.

These computer program instructions may also be loaded to the computer or the other programmable data processing terminal devices, so that a series of operation steps are executed in the computer or the other programmable data processing terminal devices to produce processing implemented by the computer, and the instructions executed in the computer or the other programmable data processing terminal devices provide steps of implementing the functions designated in one or more flows of the flow diagrams and/or one or more blocks of the block diagrams.

Although the preferred embodiments of the present disclosure have been described, other changes and modifications could be made to these embodiments by those skilled in the art once they get the basic creative concepts. Accordingly, the appended claims are intended to be interpreted as covering the preferred embodiments and all the changes and modifications falling within the scope of the present disclosure.

Finally, it should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or terminal devices including a series of factors not only include those factors, but also include other factors listed implicitly, or further include inherent factors of the processes, methods, articles or terminal devices. In the absence of more limitations, the factors defined by the statement “include one . . . ” do not exclude other identical factors in the processes, methods, articles or terminal devices including said factors.

The vehicle data processing method and the vehicle terminal provided by the present disclosure are introduced in detail above, specific examples are applied in the description to illustrate the principle and embodiments of the present disclosure, and the above embodiments are merely used for illustrating the technical solutions of the present disclosure, rather than limiting the present disclosure; although the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to part of the technical characteristics thereof; and these modifications or substitutions do not make the nature of the corresponding technical solutions depart from the spirit and scope of the technical solutions of the respective embodiments of the present disclosure.

What is claimed is:

1. A vehicle data processing method, comprising:
receiving a running data sharing packet sent by a first peripheral device in a vehicular temporary network, wherein the running data sharing packet comprises road condition data shot by a front vehicle;
sharing the running data sharing packet with a second peripheral device in the vehicular temporary network; and
determining the information of the front road according to the road condition data shot by the front vehicle, and displaying the information of the front road.

2. The method of claim 1, wherein the receiving a running data sharing packet sent by a first peripheral device in a vehicular temporary network comprises:
receiving a first broadcast message sent by a first peripheral device from a vehicular temporary network, and acquiring a running data sharing packet from the first broadcast message;
the sharing the running data sharing packet with a second peripheral device in the vehicular temporary network comprises:
generating a second broadcast message according to the running data sharing packet; and
sharing the second broadcast message with the vehicular temporary network within a preset time period, so that the second broadcast message is sent to a second peripheral device in the vehicular temporary network within the preset time period.

3. The method of claim 1, wherein the determining the information of the front road according to the road condition data shot by the front vehicle, and displaying the information of the front road further comprise:
acquiring road condition position data from the road condition data shot by the front vehicle;
acquiring current vehicle position data;
marking the road condition position data and the current vehicle position data into map data to obtain information of the front road generated from the marked map data; and
displaying the marked map data.

4. The method of claim 3, further comprising:
acquiring road condition picture data from the road condition data shot by the front vehicle, and displaying the road condition picture data.

5. The method of claim 3, further comprising:
acquiring current running route information; and
adjusting the running route information according to the road condition position data to obtain adjusted running route information.

6. The method of claim 3, further comprising:
acquiring road condition audio data from the road condition data shot by the front vehicle, and playing the road condition audio data.

7. The method of claim 1, further comprising:
generating network data according to the running data sharing packet, and uploading the network data to a server through a mobile network, so that the server can process the road condition data.

8. The method of any of claim 1, wherein the peripheral device comprises
other vehicle terminal based on V2X communication between a vehicle and a roadside fixed device or the roadside fixed device in the vehicular temporary network.

9. The method of any of claim 2, wherein the peripheral device comprises:
other vehicle terminal based on V2X communication between a vehicle and a roadside fixed device or the roadside fixed device in the vehicular temporary network.

10. The method of any of claim 3, wherein the peripheral device comprises:
other vehicle terminal based on V2X communication between a vehicle and a roadside fixed device or the roadside fixed device in the vehicular temporary network.

11. The method of any of claim 4, wherein the peripheral device comprises:
other vehicle terminal based on V2X communication between a vehicle and a roadside fixed device or the roadside fixed device in the vehicular temporary network.

12. The method of any of claim 5, wherein the peripheral device comprises:
other vehicle terminal based on V2X communication between a vehicle and a roadside fixed device or the roadside fixed device in the vehicular temporary network.

13. The method of any of claim 6, wherein the peripheral device comprises:
other vehicle terminal based on V2X communication between a vehicle and a roadside fixed device or the roadside fixed device in the vehicular temporary network.

14. The method of any of claim 7, wherein the peripheral device comprises:
other vehicle terminal based on V2X communication between a vehicle and a roadside fixed device or the roadside fixed device in the vehicular temporary network.

15. A vehicle terminal, comprising a vehicle and roadside fixed device communication module, a processor and a display, wherein,
the vehicle and roadside fixed device communication module is used for receiving a running data sharing packet sent by a first peripheral device in a vehicular temporary network, and sharing the running data sharing packet with a second peripheral device in the vehicular temporary network, wherein the running data sharing packet comprises road condition data shot by a front vehicle;
the processor is used for determining the information of the front road according to the road condition data shot by the front vehicle; and
the display is used for displaying the information of the front road.

16. The vehicle terminal of claim 15, wherein,
the vehicle and roadside fixed device communication module is used for receiving a first broadcast message sent by a first peripheral device from a vehicular temporary network, acquiring a running data sharing packet from the first broadcast message, generating a second broadcast message according to the running data sharing packet, and sharing the second broadcast message to the vehicular temporary network within a preset time period, so that the second broadcast message is sent to a second peripheral device in the vehicular temporary network within the preset time period.

17. The vehicle terminal of claim 15, further comprising
a global positioning system module, used for acquiring road condition position data from the road condition data shot by the front vehicle, acquiring current vehicle position data, and marking the road condition position data and the current vehicle position data into map data to obtain information of the front road generated from the marked map data;
wherein the display is further used for displaying the marked map data.

18. The vehicle terminal of claim 17, wherein,
the processor is further used for acquiring road condition picture data from the road condition data shot by the front vehicle; and
the display is further used for displaying the road condition picture data.

19. The vehicle terminal of claim 11, wherein,
the processor is further used for acquiring current running route information, and adjusting the running route information according to the road condition position data to obtain adjusted running route information.

20. The vehicle terminal of claim 17, further comprising a player,
wherein the processor is further used for acquiring road condition audio data from the road condition data shot by the front vehicle; and
the player is used for playing the road condition audio data.

21. The vehicle terminal of claim 15, further comprising:
a mobile communication module, wherein
the mobile communication module is used for generating network data according to the running data sharing packet, and uploading the network data to a server through a mobile network, so that the server can process the road condition data.
